(19) United States
(12) Patent Application Publication
(10) Pub. No.: US 2016/0374366 A1
(43) Pub. Date: Dec. 29, 2016

(54) Compositions for Adhering Seasonings on Food Substrates

(71) Applicant: Morton Salt, Inc., Chicago, IL (US)

(72) Inventors: Molly I-Chin Busby, Geneva, IL (US); Zachary K. Gooding, Bloomingdale, IL (US); John MacKinnon, Vernon Hills, IL (US)

(73) Assignee: Morton Salt, Inc., Chicago, IL (US)

(21) Appl. No.: 14/747,601

(22) Filed: Jun. 23, 2015

(51) Int. Cl. A23L 1/22; A23L 1/164; A23L 1/00; A23L 1/237

(52) U.S. Cl. CPC A23L 1/22016; A23L 1/237; A23L 1/1641; A23L 1/005; A23V 2002/00

(57) ABSTRACT

Compositions for adhering seasonings or flavorings on food substrates, a method for making the compositions, and a method for applying the composition to a food substrate are described. The food substrate may be any shelf-stable food known in the art such as crackers, chips, pretzels, crispy bread products, popcorn, or nuts. The seasoning or flavoring may be salts, herbs spices, or solid flavorants that might complement the food substrate.The compositions are free flowing.

The present disclosure relates to compositions for adhering seasonings on food substrates, to methods of making such compositions, and to methods of using such compositions.

Consumers seek snack food products that have various different flavor or seasoning profiles. As a result, there is a need to provide seasonings or flavorants on the surface of snack food products. Typically, oils and fats are used to adhere the seasonings and/or flavorants to the snack food products. But, many consumers desire a healthier alternative to oils and fats. The compositions and methods described below address some of these issues.

### SUMMARY

One embodiment includes a free-flowing seasoning composition for application on a surface of an edible food substrate. The free-flowing seasoning composition includes a plurality of seasoning particles in an amount from about 99 wt % to about 99.9999 wt % of the free-flowing seasoning composition and from about 0.0001 wt % to about 1 wt % of at least one edible adhesive, wherein the at least one adhesive is provided on an outer surface of the seasoning particles.

It is contemplated that the free-flowing seasoning composition may include more than a single type of seasoning particle. For example, the composition may include a first type of seasoning particles, e.g., salt, and a second type seasoning particles, e.g., pepper. In this instance, to achieve a desired amount of adhesion of both types of seasoning on the surface of the edible food substrate, it is contemplated that one type of adhesive would be used with the first type of seasoning particles and a second type would be used with the second type of seasoning particles. Thus, a first adhesive is applied to the first seasoning particles and the second adhesive is applied to the second seasoning particles. Thereafter, each of the first and second seasoning particles can be mixed with each other prior to application on the food substrate. Alternatively, each of the first and second seasoning particles can be separately applied on the food substrate.

Of course, the above example describes the use of two types of seasoning particles; but one skilled in the art would appreciate that any number of seasoning particles could be used to provide a desired flavor profile. And, in this regard, any number of adhesives (or even a single adhesive) could be used so that a particular adhesive is matched to a particular seasoning particle, as explained further.

Another embodiment includes a snack food that includes from about 95 wt % to about 99.5 wt % of a food substrate and from about 0.5 wt % to about 5 wt % of a free-flowing seasoning composition. The free flowing composition includes a plurality of seasoning particles wherein the particles are present in an amount from about 99 wt % to about 99.9999 wt % of the seasoning composition and at least one edible adhesive provided on an outer surface of the particles, wherein the adhesive is present in an amount from about 0.0001 wt % to about 1 wt % of the seasoning composition.

Another embodiment relates to a method for preparing adherent coated seasoning particles. The method includes providing a liquid adhesive composition and then applying the liquid adhesive composition onto a surface of a plurality of seasoning particles wherein the adhesive composition is applied by spraying micron sized drops at ambient temperature to provide a plurality of adherent coated seasoning particles. It will be appreciated that it may be desirable or even necessary to solubilize some adhesives with water or other edible liquids to provide an edible adhesive composition. In any event, the liquid adhesive composition has a viscosity at about 20° C. from about 20 cP to about 1000 cP. Where the adhesive needs to be solubilized, the viscosity is measured using a 25 wt % concentration of the adhesive.

Another embodiment relates to a method for producing a flavored snack food product. The method includes providing a plurality of food substrates; providing a plurality of free flowing adherent coated seasoning particles; and applying the adherent coated seasoning particles to the food substrates to form the flavored snack food product. The resulting flavored snack food product exhibits an adherent efficiency of at least 50%.

Unless otherwise noted all percentages used in the following description are by weight. It should be appreciated that above description is merely for illustrative purposes and are not intended to limit the scope of the disclosure

### BRIEF DESCRIPTION OF THE DRAWINGS

FIG. 1 is a graphical depiction of the Hanson Solubility Parameters of a seasoning particle (salt) and various adhesives.

FIG. 2 is a graph of adhesion or adherent efficiency of various adherent-coated seasoning particles applied to a surface of unsalted saltine crackers.

FIG. 3 is a graph of adhesion or adherent efficiency of various adherent-coated seasoning particles applied to a surface of either baked chips or fried chips.

FIG. 4 is graph of adhesion or adherent efficiency of various adherent-coated seasoning particles applied to a surface of either baked chips or fried chips.

FIG. 5 is graph of adhesion or adherent efficiency of various adherent-coated seasoning particles applied to a surface of either baked chips or fried chips.

FIG. 6 is graph of adhesion or adherent efficiency of various adherent-coated seasoning particles applied to a surface of either baked chips or fried chips.

### DETAILED DESCRIPTION

Shelf-stable free flowing adhesive-coated seasoning particles are described and are useful as a topping for food substrates to provide desired flavor profiles. The coated seasoning particles, when applied to food substrates, achieve at least a 50% adherent efficiency. As a result and advantageously, the application rate and amount of seasoning particles to the food substrate can be reduced to achieve the desired flavor profile. Further, the amount of wasted seasoning particles is reduced.

The food substrate can be any food product. However, it is thought that the adhesive-coated seasoning particles will be useful in preparing snack food products such as, but not limited to chips, tortilla chips, potato chips, corn chips, crackers, pretzels, popcorn, nuts, cereals, cookies, potatoes, French Fries, mixtures of the above and the like.

The seasoning particles include known seasonings, flavorants, herb, spices and the like that are known in the art. The seasoning particles include, but are not limited to, salt, flake salt, dendritic salt, black pepper, sugar, onion, garlic, sour cream, hot pepper, white pepper, parsley, cheese, ginger, barbeque, herbs, paprika, rosemary, mint, caraway, sesame seeds, poppy seeds, sage, thyme, basil and the like.

Generally, the seasoning particles will have a maximum median particle size of less than about 14 mm before the adhesive is applied. In some embodiments, the seasoning particles will have a median particle size from about 1 μm to about 14 mm, from about 10 μm to about 13.5 mm, from about 20 μm to about 13 mm.

The seasoning particles are coated with a liquefied adhesive, which is then solidified, to obtain adherent-coated seasoning particles. As used in this specification, the phrase adherent-coated seasoning particles refers to shelf-stable seasoning particles having a top surface having a minimum of about 10% of the surface of each seasoning particle is covered with adhesive. In other embodiments, from about 30% to about 100% or from about 40% to about 90%, or from about 50% to about 80%, or about 50% of the top surface each seasoning particle is covered with the adhesive.

Generally adhesives useful in the compositions and methods described in this specification include, but are not limited to a single substance, a mixture of substances, blends of homogeneous substances, blends of non-homogeneous substances, blends of homogeneous and non-homogeneous substances, dispersions, emulsions, microemulsions, nanoemulsions, and mixtures of the above, where appropriate.

Exemplary adhesive substances can include, but are not limited to water, sugars, polysaccharides, wheat proteins, starches, natural gums, corn starches, glycerin, polyols, hydrocolloids, plant protein, maltodextrin, similar such substances and mixtures thereof, where appropriate.

In addition, while it is desirable to reduce or limit the amounts of fats and oils (whether hydrogenated or not) it has been found that fats and oils are suitable adhesives. Accordingly, fats and oils alone or preferably in mixtures with water and the other substances noted in the preceding paragraph may be useful as adhesives in the compositions and methods described in this specification. However, it has generally been found that blends of oils and fats with other non-oil and non-fat substances are useful

Examples of suitable adhesives include, but are not limited to the following:

Xanthan gum, NovaXan 40T.

Corn starch, which is derived from the corn grain.

Lecithin, from soy, has phospholipids as the major component. Lecithin is a known emulsifier for water and oil.

Gum Arabic, also known as acacia gum, is a natural gum made of hardened sap taken from the acacia tree. Gum Arabic is a complex mixture of glycoproteins and polysaccharides.

Glucose and Dextrose.

N-Tack® is derived from waxy corn starch. At a 25-35 wt % concentration it has a low viscosity.

SweetNNeat®Tack Blend (“SSN Tack Blend) which is a blend of Maltodextrin Lactose and Xanthan gum.

Prolite® 100 is composed of functional wheat protein isolates.

Clintose® CR10 is dextrose equivalent (DE) maltodextrin. Maltodextrin consists of D-glucose units connected in chains of variable length. Higher DE value indicates shorter glucose chains and higher sweetness and solubility.

Fibersol®-2 is a spray dried powder produced from cornstarch and has a 12 dextrose equivalent (DE).

METHOCEL® is a family of modified cellulosic gums composed of hydrocolloids. They can include hydroxypropylmethylcellulose (METHOCEL E-19, METHOCEL E-4M, METHOCEL K4M, METHOCEL K 100M) and methylcellulose (METHOCEL A4C, METHOCEL A-15 and METHOCEL A-4M).

CARBOWAX® Polyethylene Glycol is available in a range of average molecular weights for example, polyethylene glycol 600, polyethylene glycol 1000, polyethylene glycol 1450, polyethylene glycol 4000, and polyethylene glycol 8000.

Glycerin.

Oils such as palm, kernel, olive, sunflower, coconut, peanut, soybean, corn, pecan, cottonseed, canola, rapeseed, flaxseed and other known oils, whether hydrogenated or unhydrogenated.

Typically the above adhesives are mixed with an edible liquid such as water to provide an adhesive concentration from about 0.01 wt % to about 0.5 wt %, which is then applied to the seasoning particles.

In one embodiment, the adhesive is applied to the seasoning particles such that the final adherent-coated seasoning particles (the composition) includes from about 0.0001 wt % to about 1 wt % of the adhesive and from about 99 wt % to about 99.9999 wt % of seasoning particles. In other embodiments, the composition includes from about 0.0001 wt % to about 0.5 wt % of the adhesive and from about 99.5 wt % to about 99.9999 wt % of seasoning particles, or from about 0.0001 wt % to about 0.1 wt % of the adhesive and from about 99.9 wt % to about 99.9999 wt % of seasoning particles.

Surprisingly, it has been found that despite the apparent low level of adhesive when compared to the seasoning particles, the resulting adherent-coated seasoning particles exhibit excellent adhesion properties on the food substrates to which the adherent-coated seasoning particles are applied.

The adherent-coated seasoning particles are free flowing at ambient temperature, i.e., at about 20° C. The term free flowing refers to the ability of the adherent-coated seasoning particles to flow without aid or agitation as determined by the funnel flow parameter test, described below.

The funnel flow parameter test uses a funnel having a size sufficient to accommodate at least 100 g of the adherent-coated seasoning particles and having an 8 mm opening. To determine if the adherent-coated seasoning particles are free-flowing, 100 g of adherent-coated seasoning particles is transferred into the funnel at ambient temperature (i.e., about 20° C.) and watched to see how much, if any, of the 100 g of adherent-coated seasoning particles pass through the 8 mm opening without tapping, agitation, or vibrating of the funnel. If more than 80 g passes through the opening without tapping, agitation, or vibrating of the funnel, the adherent-coated seasoning particles are considered to be free-flowing.

The adhesive can be applied to the seasoning particles off-line, in a central location, or in some location other than where the food substrates are prepared, and the adherent-coated seasoning particles may be stored in any suitable location. Preferably, the adherent-coated seasoning particles should be stored at a location where the temperature is less than about 35° C.

Advantageously, using adherent coated seasoning particles according to the present disclosure permits less adhesive to be applied to the seasoning particles. Another advantage is that the amount of “bounce-off” or waste of adherent coated seasoning particles is reduced.

A method to produce the adherent-coated seasoning particles will now be described. In one embodiment, seasoning particles are provided to a fluidizing vessel where the particles are fluidized, or suspended by the introduction of air to the vessel. The liquid adhesive is provided in a separate vessel and then introduced into the fluidizing vessel, preferably as a mist. As noted above, the adhesive may be solubilized with an appropriate liquid solvent to the desired concentration and/or viscosity.

As the seasoning particles move through the fluidizing vessel, they are at least partially covered with adhesive to form adhesive or adherent coated seasoning particles. The coated seasoning particles are removed from the fluidizing vessel and exposed to cooler air to solidify, if necessary, the adhesive on the surface of the seasoning particles. The adherent-coated seasoning particles may be sent to further processing to produce the topped snack food substrate or stored for later use.

Another method to produce the adherent-coated seasoning particles may include providing the seasoning particles. Separately, the liquid adhesive is provided and applied to the seasoning particles by spraying micron sized drops at ambient temperature onto the surface of the seasoning particles to produce the adherent-coated seasoning particles. As noted above, the adhesive may be solubilized with an appropriate liquid solvent to the desired concentration and/or viscosity.

The adhesive may or may not need to be solubilized depending on the particular adhesive selected. For instance, if the adhesive is simply water, then of course, it need not be solubilized. Typically, the adhesive or adhesive solution will have a viscosity at about 20° C. from about 1 cP to about 2,000 cP, or from about 1 cP to about 1,000 cP, or from about 1 cP to about 500 cP, or from about 1 cP to about 250 cP, or from about 1 cP to about 120 cP or from about 5 cP to about 120 cP, or from about 10 cP to about 120 cP, of from about 20 cP to about 120 cP.

If the adhesive needs to be solubilized, the viscosity is such that an approximate 25% concentration of the adhesive at a temperature of about 20° C. is from about 20° C. from about I cP to about 2,000 cP, or from about 1 cP to about 1,000 cP, or from about 1 cP to about 500 cP, or from about 1 cP to about 250 cP, or from about 1 cP to about 120 cP or from about 5 cP to about 120 cP, or from about 10 cP to about 120 cP, of from about 20 cP to about 120 cP. Table 1 below illustrates exemplary although not limiting examples of solubilized adhesives with suitable viscosities.

TABLE 1

| | Solute | Solvent | | | | Temp | | Viscosity |
|---|---|---|---|---|---|---|---|---|
| Component | (g) | (g) | Conc. | Spindle | Torque % | C. | RPM | (cP) |
| Fibersol | 50.034 | 149.923 | 25.02% | 2 | 5.5% | 20.3 | 100 | 20.0 |
| Gum Arabic | 50.071 | 150.105 | 25.01% | 2 | 28.7% | 21.2 | 100 | 114.8 |
| N Tack | 50.281 | 150.822 | 25.00% | 2 | 17.5% | 20.5 | 100 | 70.0 |
| SNN Tack Blend | 50.649 | 149.976 | 25.25% | 2 | 15.2% | 21.2 | 100 | 60.8 |
| Clintose CR10 | 50.0 | 150 | 25% | 2 | 8.6% | 21.0 | 100 | 34.4 |
| Dextrose | 50 | 150 | 25% | 2 | 3.6% | 21.0 | 100 | 14.4 |

It is contemplated that a mixture of different types of adherent-coated seasoning particles may be applied to a single type of food substrate. For example, it is contemplated to apply both adherent-coated salt particles and adherent-coated black pepper particles to a single food substrate. Consequently, it is contemplated that a different adhesive may be selected and used to coat each type of seasoning. For example, it is known that salt is hydrophilic and thus a hydrophilic adhesive is selected to be applied to the salt particles. However, black pepper is hydrophobic and if a hydrophilic adhesive is sought to be applied to the black pepper, the hydrophilic adhesive would not adequately interact with and be retained on the surface of the black pepper. Thus, a hydrophobic adhesive would be used to coat the black pepper. On the other hand, in some instances, it will be appreciated that a single adhesive will be effective for each type of seasoning sought to be used.

To assess the type of adhesive that will be useful for coating each type of seasoning particle, the inventors believe that the Hansen Solubility Parameter is a useful tool to select an appropriate adhesive for the selected seasoning particle.

### Hansen Solubility Parameter (“HSP”)

The adhesive selected for application on a particular type of seasoning particle is based upon solubility parameters and cohesion properties explained by Charles Hansen in “Hansen Solubility Parameters:A User's Handbook” by Charles M. Hansen, CRC Press (2007) and in “The CRC Handbook and Solubility Parameters and Cohesion Parameters,” Edited by Allan F. M. Barton (1999). Each material is defined by three points in 3D space and these three points are known as the Hansen Solubility Parameters (HSP) which may be defined as follows.

Solubility parameters are theoretically calculated numerical constants which are a useful tool in predicting the ability of an adhesive to adhere both to the seasoning particles and to the food substrate. There are three Hansen empirically-and theoretically-derived solubility parameters, a dispersion-force component (δ_{D}), a polar or dipole interaction component (δ_{P}) and a hydrogen-bonding component (δ_{H}). Each of the three parameters (i.e., dispersion, polar, and hydrogen bonding) represents a different characteristic of solvency, or solvent capability. In combination, the three parameters are a measure of the overall strength and selectivity of a solvent. The Total Hansen solubility parameter, which is the square root of the sum of the squares of the three parameters mentioned previously, provides a more general description of the solvency of the solvents. Individual and total Solubility Parameter units are given in MPa^{0.5} or (J/cc)^{0.5}.

The Hansen solubility parameters can be calculated by “Molecular Modeling Pro” software, version 5.1.9 (ChemSW, Fairfield Calif., www.chemsw.com) or Hansen Solubility from Dynacomp Software.

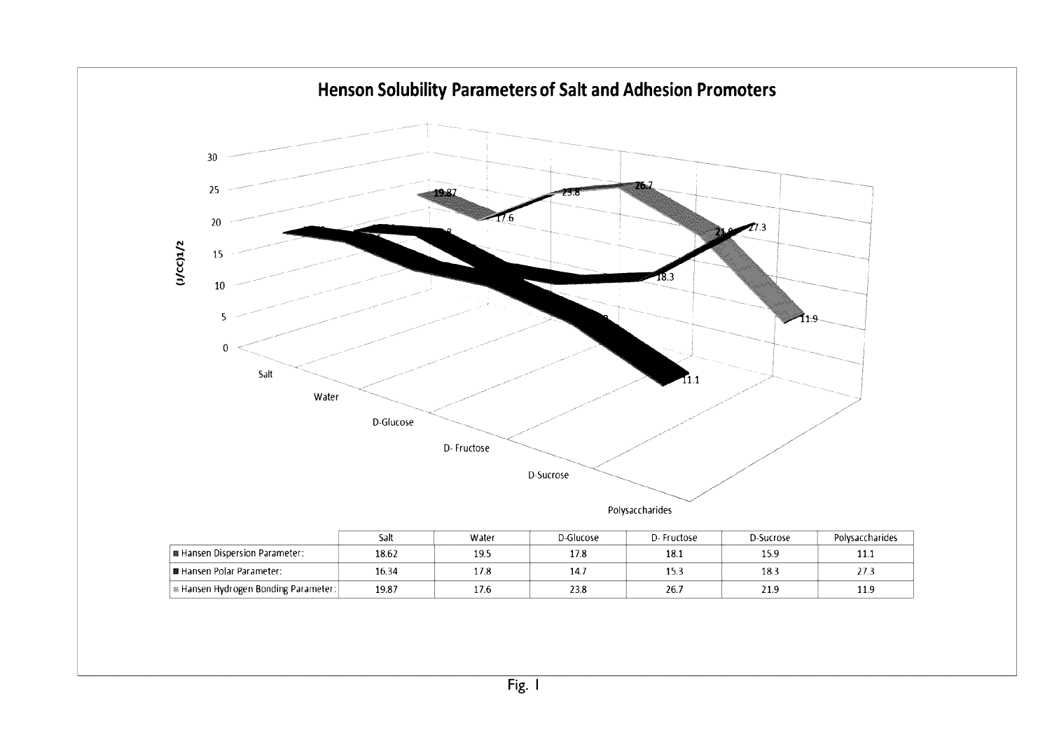

Table 2 shows various Hansen Solubility Parameters of salt, water, and various adhesives and FIG. 1 provides a graphical representation.

TABLE 2

| | SOLUBILITY PARAMETERS, (J/cc)1/2 |
|---|---|
| CHEMICAL STRUCTURE | Dispersion, Polar, Hydrogen Bonding |
| Sodium Chloride | 18.62, 16.34, 19.81 |
| Water | 19.5, 17.8, 17.6 |
| 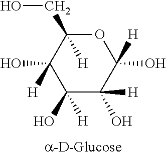 | 17.8, 14.7, 23.8 |
| 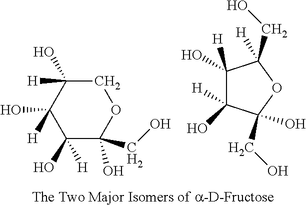 [SMILES: OC[C@]1(O)OC[C@@H](O)[C@@H](O)[C@@H]1O ; OC[C@H]1O[C@@](O)(CO)[C@@H](O)[C@@H]1O] | 18.1, 15.3, 26.7 |
| 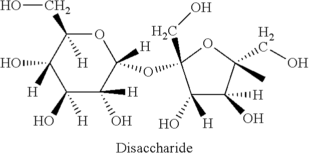 | 15.9, 18.3, 21.9 |
| 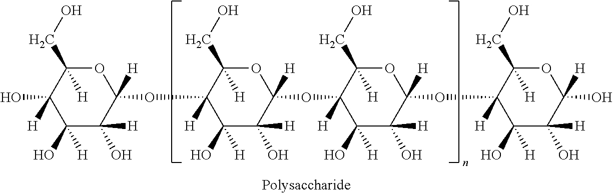 | 11.1, 27.3, 11.9 |
| 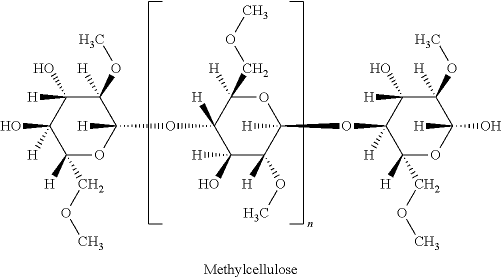 | 17.4-18.3, 14.6-16.5, 15.1-19.4 |
| 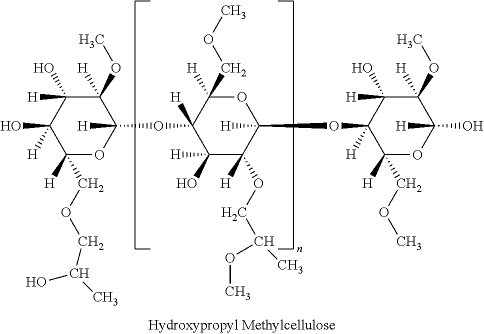 | 17.4-18.3, 14.6-16.5 15.1-19.4 High Hydroxy Propyl Substitution 17.3, 9.9, 13.5 |

One embodiment of a method to produce seasoning topped food products will now be described. A plurality of food substrates are provided to a tumbler, seasoning drum, or other suitable vessel. Applicants will refer to a tumbler hereinafter for consistency and simplicity purposes, but this reference is not meant to limit the scope of the invention. A plurality of adherent-coated seasoning particles are provided to the tumbler, dispensed from a height at the receiving end of the tumbler. In one embodiment, the adherent-coated seasoning particles are dispensed from a height of about 10-50 centimeters, for example about 10-30 centimeters, above the bed of food substrates. One skilled in the art will be able to determine the optimum height for dispensing the adherent-coated seasoning particles based on the equipment used and the temperature of the food substrates.

Typically, the adherent-coated seasoning particles are delivered to the food substrates at ambient temperature, although it is contemplated that the adherent-coated seasoning particles can be delivered at a temperature greater than ambient. For example, it is contemplated that it may be desirable if the adhesive on the adherent-coated seasoning particles adhesive is softened so that the adherent-coated seasoning particles become tacky and adhere to the food substrates upon contact, but not enough that the adhesive is displaced from the seasoning particles. Generally, the surface temperature of the food substrate provides sufficient heat to soften the adhesive as the adherent-coated seasoning particles contact the surfaces of the food substrates.

In another embodiment, hot air may be introduced into the tumbler to contact the adherent-coated seasoning particles and heat the adhesive as the adherent-coated seasoning particles descend within the tumbler. The temperature profile of the hot air introduced into the tumbler must be such that the adhesive does not completely liquefy before the adherent-coated seasoning particles contact the food substrates or the adhesive is displaced from the seasoning particles, leading to insufficient adherence of the adherent-coated seasoning particles on the food substrate.

With the above in mind, it will be appreciated that the ambient temperature may be higher than about 20° C. Accordingly, it is contemplated that the adherent-coated seasoning particles are delivered or applied to the food substrates at a temperature in the range from about 15° C. to about 120° C., or from about 20° C. to about 60° C., or from about 25° C. to about 35° C. or suitable temperatures within those ranges.

The adherent-coated seasoning particles are then applied to the surfaces of the food substrates to obtain topped food substrates. The adhesive attaches to the surface of the food substrates due to its tackiness, and subsequently chemically and physically adheres the seasoning particles to the surface of the food substrates. As the adhesive solidifies, it physically entraps the seasoning particles on the surface of the food substrates.

In other embodiments of the method for production of seasoning topped snack food products, the food substrate could be provided on a travelling belt such that as the food substrate passes beneath a seasoning applicator device, the adherent-coated seasoning particles are delivered to a surface of the food substrate. While the above methods are useful, it is contemplated that the adherent-coated seasoning particles can be applied to the food substrate in any known manner such as by tumbling, a topping unit, or any other means for providing adherent-coated seasoning particles on a surface of the food substrates.

Advantageously, the final snack food product exhibits an adherent efficiency of at least 50%. The term “adherent efficiency” or “seasoning adherent efficiency” refers to a ratio of the amount of adherent-coated seasoning retained on the food substrate to the amount of adherent-coated seasoning applied to the food substrate. Accordingly, in some embodiments the final snack food product exhibits an adherent efficiency of at least 60%, or at least 70%, or at least 80%, or at least 90%.

The final snack food product obtained by the above methods includes a food substrate, adhesive, and seasoning particles.

### EXAMPLES

### Example 1

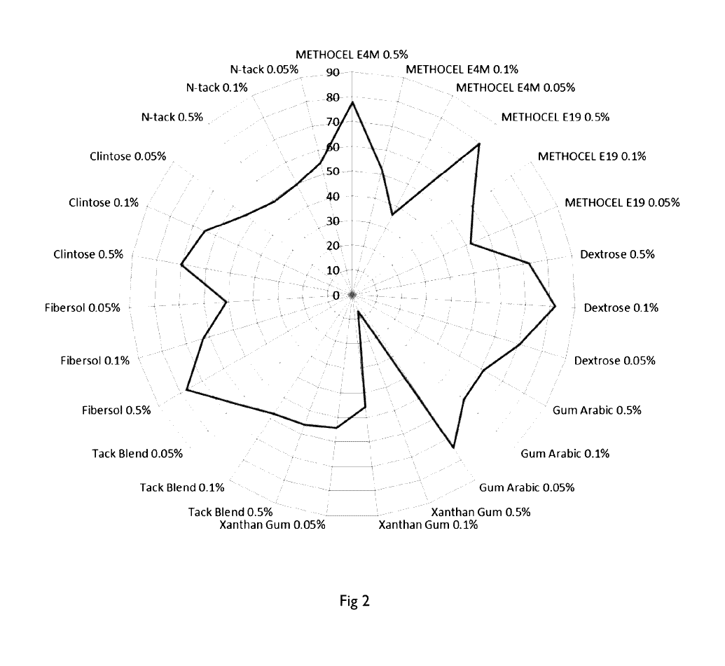

Various adhesives were prepared at concentrations of 0.05%, 0.1%, and 0.5% and applied to coarse (top flake) salt particles (having a median particle size between about 0.30 mm to about 0.84 mm) at a ratio of about I part of adhesive to 9 parts of salt particles to form a free flowing seasoning composition. An amount (0.1 gram) of each seasoning composition was applied to one side of four unsalted crackers, after which the topped crackers were baked in an oven for one minute at 200° F. The four crackers were weighed and then placed into an 8 mesh sieve where they were shaken for 10 seconds, after which the four crackers were weighed to determine the percentage of seasoning composition remaining on the crackers. This process was repeated for each adhesive. The results are shown in FIG. 2.

### Example 2

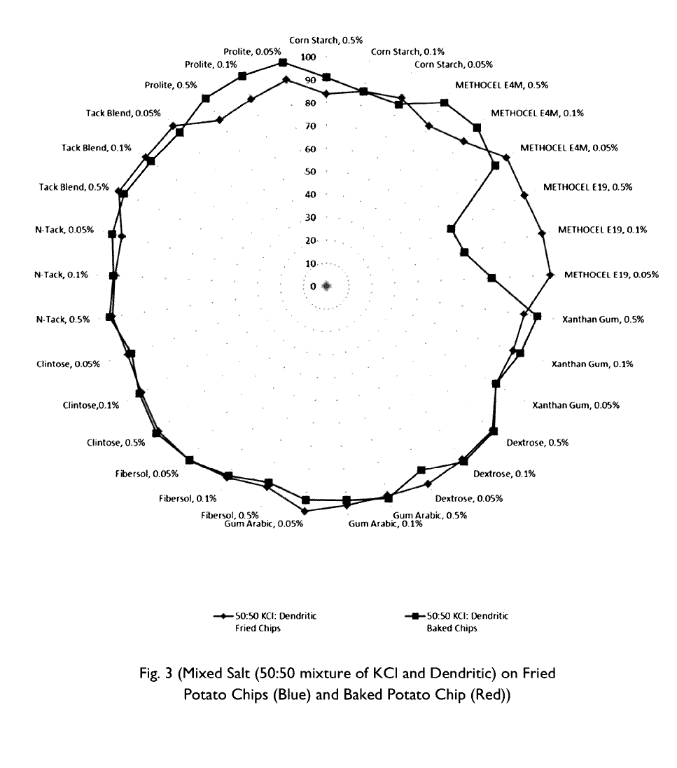

Various adhesives were prepared at concentrations of 0.05%, 0.1%, and 0.5% and applied to a 50:50 mixture of KCI and modified (Dendritic) salt particles (having a median particle size between about 0.11 mm to about 0.40 mm) at a ratio of about 1 part of adhesive to 9 parts of the salt particles to form a free flowing seasoning composition An amount (0.1 gram) of each seasoning composition was applied to one side of four fried chips, after which the topped chips were baked in an oven for one minute at 250° F. The four chips were weighed and then placed into a No. 8 shaking pan where they were shaken for 10 seconds, after which the four chips were weighed to determine the percentage of seasoning composition remaining on the crackers. This process was repeated for each adhesive and was conducted on baked chips. The results are shown in FIG. 3 and presented in Table 3 below.

### Example 3

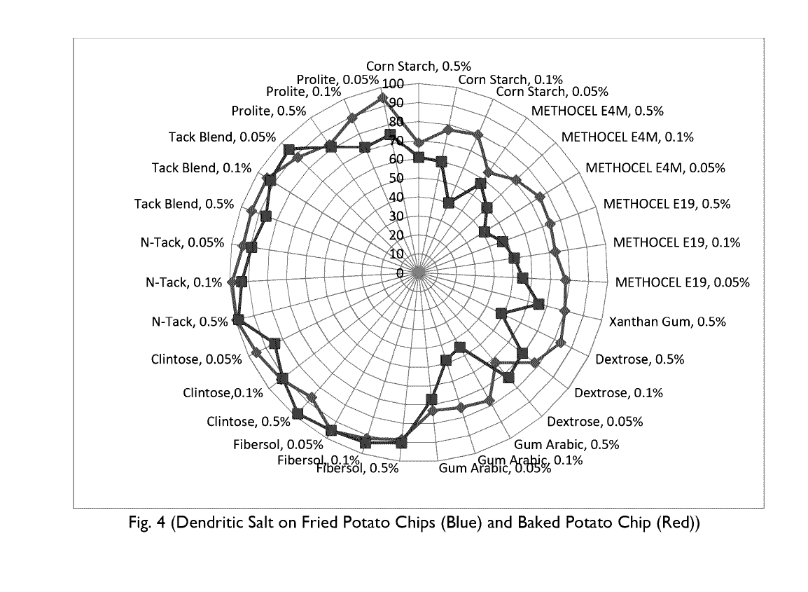

Various adhesives were prepared at concentrations of 0.05%, 0.1%, and 0.5% and applied to modified (Dendritic) salt particles (having a median particle size between about 0.11 mm to about 0.40 mm) at a ratio of about I part of adhesive to 9 parts of the salt particles to form a free flowing seasoning composition. An amount (0.1 gram) of each seasoning composition was applied to one side of four fried chips, after which the topped chips were baked in an oven for one minute at 250° F. The four chips were weighed and then placed into a No. 8 shaking pan where they were shaken for 10 seconds, after which the four chips were weighed to determine the percentage of seasoning composition remaining on the crackers. This process was repeated for each adhesive and was conducted on baked chips. The results are shown in FIG. 4 and presented in Table 3 below.

### Example 4

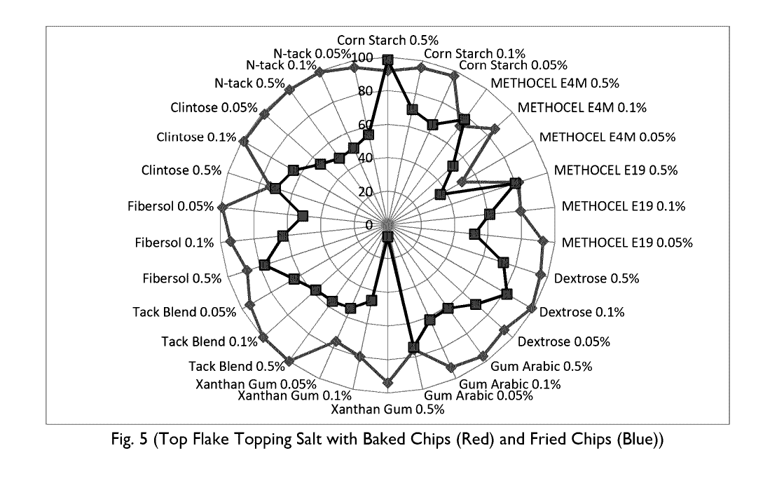

Various adhesives were prepared at concentrations of 0.05%, 0.1%, and 0.5% and applied to coarse (top flake) salt particles (having a median particle size between about 0.30 mm to about 0.84 mm) at a ratio of about I part of adhesive to 9 parts of the salt particles to form a free flowing seasoning composition. An amount (0.1 gram) of each seasoning composition was applied to one side of four fried chips, after which the topped chips were baked in an oven for one minute at 250° F. The four chips were weighed and then placed into a No. 8 shaking pan where they were shaken for 10 seconds, after which the four chips were weighed to determine the percentage of seasoning composition remaining on the crackers. This process was repeated for each adhesive and was conducted on baked chips. The results are shown in FIG. 5 and presented in Table 3 below.

TABLE 3

| | Example 2 | | Example 3 | | | |
|---|---|---|---|---|---|---|
| | 50:50 | 50:50 | Modified | Modified | Example 4 | |
| | KCl:Modified | KCl:Modified | on Fried | on baked | Coarse on | Top Flake on |
| | Fried Chips | Baked Chips | Potato Chips | Potato Chips | Fried Chips | Baked Chips |
| Corn Starch, 0.5% | 83.77 | 90.93 | 68.64 | 60.92 | 91.71 | 98.26 |
| Corn Starch, 0.1% | 86.4 | 86.23 | 77.32 | 59.83 | 95.65 | 70.31 |
| Corn Starch, 0.05% | 88.25 | 85.14 | 79.51 | 40.22 | 96.96 | 65.51 |
| METHOCEL E4M, 0.5% | 82.88 | 94.99 | 64.48 | 57.36 | 72.99 | 67.2 |
| METHOCEL E4M, 0.1% | 86.98 | 95.28 | 71.09 | 49.86 | 85.7 | 60.8 |
| METHOCEL E4M, 0.05% | 96.37 | 90.24 | 75.54 | 40.95 | 50.93 | 41.78 |
| METHOCEL E19, 0.5% | 94.93 | 59.89 | 74.21 | 47.37 | 81.75 | 71.02 |
| METHOCEL E19, 0.1% | 96.79 | 61.98 | 73.13 | 51.21 | 79.5 | 58.87 |
| METHOCEL E19, 0.05% | 97.88 | 72.24 | 77.81 | 55.14 | 92.91 | 50.99 |
| Xanthan Gum, 0.5% | 87.09 | 92.95 | 79.84 | 65.69 | 93.96 | 80.39 |
| Xanthan Gum, 0.1% | 86.17 | 89.46 | | | 79.89 | 44.54 |
| Xanthan Gum, 0.05% | 85.32 | 85.45 | | | 95.68 | 44.3 |
| Dextrose, 0.5% | 95.92 | 96.61 | 83.7 | 48.62 | 95.6 | 73.04 |
| Dextrose, 0.1% | 96.03 | 97.11 | 77.45 | 69.34 | 98.94 | 65.09 |
| Dextrose, 0.05% | 97.07 | 90.21 | 62.5 | 72.9 | 93.21 | 58.47 |
| Gum Arabic, 0.5% | 95.08 | 96.3 | 77.19 | 44.9 | 96.33 | 75.96 |
| Gum Arabic, 0.1% | 95.83 | 93.55 | 74.59 | 48.36 | 92.67 | 68.92 |
| Gum Arabic, 0.05% | 98.37 | 93.46 | 73.23 | 67.32 | 95.68 | 56.74 |
| Fibersol, 0.5% | 91.18 | 89.18 | 88.42 | 90.25 | 87.96 | 91.76 |
| Fibersol, 0.1% | 93.94 | 92.92 | 91.73 | 94.1 | 94.01 | 91.78 |
| Fibersol, 0.05% | 96.47 | 96.27 | 95.34 | 95.24 | 98.91 | 90.95 |
| Clintose, 0.5% | 96.56 | 97.85 | 86.8 | 98.1 | 73.51 | 73.51 |
| Clintose, 0.1% | 92.88 | 93.96 | 91.83 | 90.91 | 98.9 | 98.9 |
| Clintose, 0.05% | 91.51 | 89.78 | 95.52 | 84.76 | 98.63 | 98.63 |
| N-Tack, 0.5% | 94.12 | 95.33 | 99.46 | 98.39 | 99.44 | 72 |
| N-Tack, 0.1% | 92.05 | 92.86 | 98.72 | 93.67 | 99.47 | 70.98 |
| N-Tack, 0.05% | 91.53 | 95.84 | 93.98 | 89.34 | 95.79 | 76.08 |
| Tack Blend, 0.5% | 99.39 | 96.79 | 94.18 | 86.01 | 100 | 91.87 |
| Tack Blend, 0.1% | 96.41 | 93.62 | 94.4 | 92.27 | 99.73 | 90.37 |
| Tack Blend, 0.05% | 96.37 | 92.51 | 88.24 | 94.59 | 94.64 | 94.75 |
| Prolite, 0.5% | 85.71 | 97.27 | 82.51 | 81 | | |
| Prolite, 0.1% | 87.73 | 98.45 | 89.11 | 72.24 | | |
| Prolite, 0.05% | 91.47 | 99.19 | 94.46 | 74.73 | | |

### Example 5

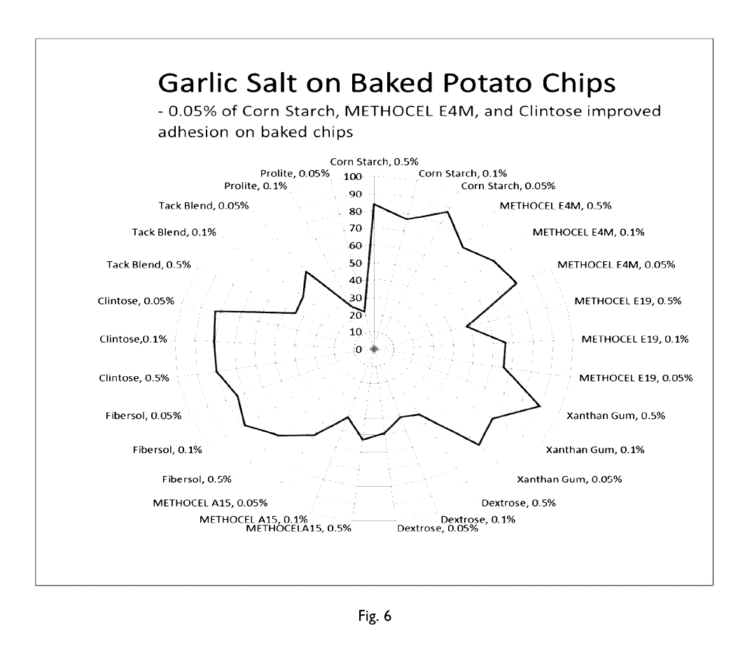

Various adhesives were prepared at concentrations of 0.05%, 0.1%, and 0.5% and applied to garlic salt particles (having a median particle size between about 0.30 mm to about 0.84 mm) at a ratio of about 1 part of adhesive to 9 parts of the salt particles to form a free flowing seasoning composition. An amount (0.1 gram) of each seasoning composition was applied to one side of four baked chips, after which the topped chips were baked in an oven for one minute at 250° F. The four chips were weighed and then placed into a No. 8 shaking pan where they were shaken for 10 seconds, after which the four chips were weighed to determine the percentage of seasoning composition remaining on the crackers. This process was repeated for each adhesive. The results are shown in FIG. 6.

While this invention has been particularly shown and described with reference to preferred embodiments, it will be understood by those skilled in the art that various changes in form and detail may be made therein without departing from the spirit and scope of the invention. The inventors expect skilled artisans to employ such variations as appropriate, and the inventors intend the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A free-flowing seasoning composition for application on a surface of an edible food substrate comprising:
a plurality of seasoning particles in an amount from about 99 wt % to about 99.9999 wt % of the composition;
from about 0.0001 wt % to about 1 wt % of at least one edible adhesive, wherein the adhesive is provided on an outer surface of the particles and at a temperature of about 20° C., the composition has a funnel flow parameter of 80 g.

2. The composition of claim 1 wherein the adhesive has a viscosity at about 20° C. from about 1 cP to about 2,000 cP.

3. The composition of claim 1 wherein the seasoning particles have a maximum median particle size of about 14 mm.

4. The composition of claim 1 wherein the seasoning particles have a median particle size from about 1 μm to about 10 mm.

5. The composition of claim 1 wherein the seasoning particles are selected from the group consisting of salt, flake salt, dendritic salt, black pepper, sugar, onion, garlic, sour cream, hot pepper, white pepper, parsley, cheese, ginger, barbeque, herbs, paprika, rosemary, mint, caraway, sesame seeds, poppy seeds, and mixtures thereof.

6. The composition of claim 1 wherein the food substrate is selected from the group consisting of chips, tortilla chips, potato chips, corn chips, crackers, pretzels, popcorn, nuts, potatoes, French Fries, and mixtures thereof.

7. The composition of claim 1 wherein a Hansen Solubility Parameter of the adhesive is compatible with a Hansen Solubility Parameter of the seasoning.

8. The composition of claim 1 comprising:
a plurality of first seasoning particles and a plurality of second seasoning particles with the first and second seasoning particles being different; and
a first adhesive and second adhesive such that the first adhesive is applied to the plurality of the first seasoning particles and the second adhesive is applied to the plurality of the second seasoning particles.

9. A snack food comprising:
about 95 wt % to about 99.5 wt % of a food substrate;
about 0.5 wt % to about 5 wt % of a free-flowing seasoning composition that includes:
a plurality of seasoning particles wherein the particles are present in an amount from about 99 wt % to about 99.9999 wt % of the seasoning composition;
at least one edible adhesive provided on an outer surface of the particles, wherein the adhesive is present in an amount from about 0.0001 wt % to about 1 wt % of the seasoning composition.

10. The composition of claim 9 wherein the snack food exhibits a seasoning adherent efficiency of at least 50%.

11. A method for preparing adherent coated seasoning particles comprising:
solubilizing an edible adhesive to provide an edible adhesive composition, wherein a 25 wt % concentration of the adhesive has a viscosity at about 20° C. from about 1 cP to about 2,000 cP;
applying the adhesive composition onto a surface of a plurality of seasoning particles wherein the adhesive composition is applied by spraying micron sized drops at ambient temperature to provide a plurality of adherent coated seasoning particles.

12. A method for producing a flavored snack food product comprising:
providing a plurality of food substrates;
providing a plurality of free flowing adherent coated seasoning particles;
applying the adherent coated seasoning particles to the food substrates to form the flavored snack food product, wherein the flavored snack food product exhibits an adherent efficiency of at least 90%.

13. The method of claim 12 wherein the adherent coated seasoning particles are applied to the food substrates at a temperature from about 15° C. to about 120° C.
